(19) United States
(12) Patent Application Publication
(10) Pub. No.: US 2025/0371060 A1
(43) Pub. Date: Dec. 4, 2025

(54) SYSTEMS AND METHODS FOR AUTOMATING MODEL PROMOTION IN MACHINE LEARNING OPERATIONS

(71) Applicant: JPMORGAN CHASE BANK, N.A., New York, NY (US)

(72) Inventors: Lucas VINH TRAN, Sheffield (GB); Jay KATUKURI, Saratoga, CA (US)

(21) Appl. No.: 19/226,609

(22) Filed: Jun. 3, 2025

Related U.S. Application Data
(60) Provisional application No. 63/655,116, filed on Jun. 3, 2024.

(51) Int. Cl. G06F 16/335

(52) U.S. Cl. CPC G06F 16/337

(57) ABSTRACT

In some embodiments, techniques described herein relate to a method including: receiving a user instruction at an application executed by an electronic device; generating, at a framework executed by a server, one or more feature groups based on the profile data; generating, at the framework, a data configuration file; generating, at the framework, a model configuration file; specifying, at the framework, a sequence of functionality steps for execution; generating, at the framework, a prediction score based on the sequence of functionality steps; saving and/or executing, at the framework, the sequence of functionality steps; and generating, at the electronic device, one or more outputs including, for example, a prediction based on the sequence of functionality steps.

### BACKGROUND

### 1. Field of the Invention

Embodiments generally relate to systems and methods for automating model promotion in machine learning operations via large language model (“LLM”).

### 2. Description of the Related Art

Conventional machine learning algorithms and generative artificial intelligence (“AI”) systems have manually crafted prompts that must be iterated until quality solutions are generated. Conventional machine learning algorithms and AI systems are inefficient at document ingestion and maintaining high performance accuracy with ingested large volumes of data. Conventional machine learning algorithms and AI systems fail to leverage embedded documents and do not have robust retrieval capabilities and so cannot provide accurate and relevant answers to user queries. Improved systems and methods will have superior onboarding capabilities, data ingestion that may be manipulated while maintaining high performance and accuracy, and highly responsive and scalable information retrieval. Improved systems and methods will include explainability for machine learning training, improvements, and compliance checks. Improved systems and methods will include deploying trained machine learning models to a production environment where they can be accessed and used to make predictions or decisions in real-time or batch mode.

### SUMMARY

Exemplary embodiments provide systems and methods for automating model promotion in machine learning operations via large language model (“LLM’) agents. According to one embodiment, a method may include receiving a user instruction at an application executed by an electronic device; generating, at a framework executed by a server, one or more feature groups based on the profile data; generating, at the framework, a data configuration file; generating, at the framework, a model configuration file; specifying, at the framework, a sequence of functionality steps for execution; generating, at the framework, a prediction score based on the sequence of functionality steps; saving and/or executing, at the framework, the sequence of functionality steps; and generating, at the electronic device, one or more outputs including, for example, a prediction based on the sequence of functionality steps.

According to one embodiment, a method may comprise receiving a user instruction at an application executed by an electronic device; generating, at a framework executed by a server, one or more feature groups based on profile data; generating, at the framework, a data configuration file; generating, at the framework, a model configuration file; specifying, at the framework, a sequence of functionality steps for execution; generating, at the framework, a prediction score based on the sequence of functionality steps; saving and executing, at the framework, the sequence of functionality steps; and generating, at the electronic device, one or more outputs including, for example, a prediction based on the sequence of functionality steps.

The method may include wherein the data configuration file is based on the profile data and specifies data characteristics including location of LLM training and evaluation data, a data reader type, a data parameter including a number of data points for LLM training and evaluation, and a number of data points used for model explainability. The method may further comprise determining, by a data loader that uploads the profile data, that the each profile data set of the profile data is associated with a customer identifier, satisfies a data quality check that ensures each personalization of the profile data is available and complete, and performs a sanity check to determine whether each personalization of the profile data is within an expected range.

The method may include, wherein the model configuration file comprises model characteristics include a model type, a model backend, a model directory to export, a model hyperparameter, and a tuning hyperparameter. The method may further comprise supporting, by the framework, batch and real-time processing based on a framework inference. The method may further comprise the profile being in a graph embedding format. The method may further comprise generating a SHAP plot for the feature groups including for feature importance and explainability. The method may further comprise regenerating the model based on the prediction being below a threshold, the regenerating being based on updating one or more parameter weights for new profile data. The method may further comprise regenerating a new LLM without updated parameters or previous inputs and with new profile data. The method may further comprise regenerating a new LLM periodically.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for automating model promotion in machine learning operations, in accordance with embodiments.

FIG. 2 is a method for automating model promotion in machine learning operations, in accordance with embodiments.

FIG. 3 is a block diagram of a computing device for implementing certain embodiments of the present disclosure.

### DETAILED DESCRIPTION

Embodiments generally relate to systems and methods for automating model promotion in machine learning operations.

Improved systems and methods consistent with the present disclosure may include receiving a user instruction at an application executed by an electronic device; generating, at a framework executed by a server, one or more feature groups based on the profile data; generating, at the framework, a data configuration file; generating, at the framework, a model configuration file; specifying, at the framework, a sequence of functionality steps for execution; generating, at the framework, a prediction score based on the sequence of functionality steps; saving and/or executing, at the framework, the sequence of functionality steps; and generating, at the electronic device, one or more outputs including, for example, a prediction based on the sequence of functionality steps.

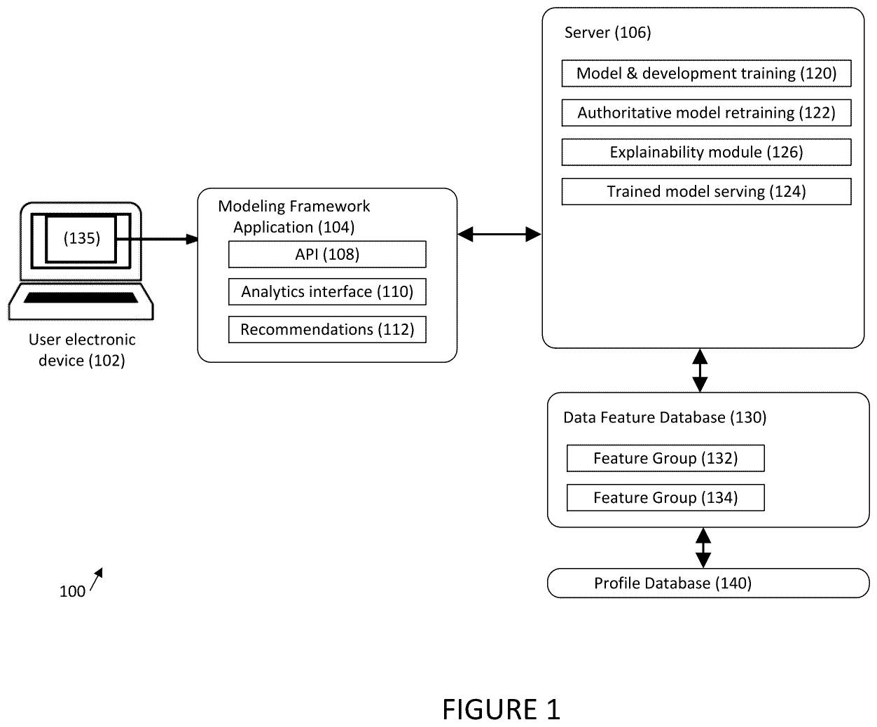

FIG. 1 is a block diagram of a system automating model promotion in machine learning operations, in accordance with embodiments.

System 100 includes a user electronic device 102 executing retrieval modeling framework application 104 available through user interface 135, server 106, data feature database 130, and profile database 140. Server 106 may comprise a network or computer including a processor executing one or more software modules and a memory for storing data accessible by the one or more software modules and instructions to execute the one or more software modules. Server 106 may comprise one or more software modules comprising model and development training 120, authoritative model retraining 122, trained model serving 124, and explainability module 126.

Model and development training 120 may support a number of models. For example, multi-GPU training and inference optimizations for a deep learning recommender model, where batch inference is optimized to run in about 30 minutes for ˜100 M users. Supports multiple backends for model implementation: TensorFlow/Keras, PyTorch, Sklearn, XGBoost, and Statsmodels. The following types of models are available (each which may be used for personalization features): graph embeddings (e.g., embedding representations for entities of an enterprise such as merchants, offers, hotels, restaurants, users, travel booking) by representing them in a graph; reinforcement learning that may include models enabling exploration of content in recommendations including a reinforcement learning (“RL”) model; a deep learning based model that ranks products or offers for users such as a deep learning recognition model (“DLRM”), attention-based transformer models, and multi-layer perception.

A reinforcement learning model in a recommender system is an approach where the system may learn to make recommendations by interacting with the environment and receiving feedback as will. Unlike traditional recommendation algorithms that rely on historical data, reinforcement learning models may focus on learning optimal strategies through trial and error. Reinforcement learning is particularly useful in dynamic environments where user preferences change over time, as it allows the recommender system to adapt and improve continuously based on real-time interactions.

Authoritative model retraining 122 may include systematically updating and improving a machine learning model by retraining it with new data or improved methodologies. This authoritative model retraining maintains the accuracy and relevance of models in production environments.

Trained model serving 124 may include deploying trained machine learning models to a production environment where they can be accessed and used to make predictions or decisions in real-time or batch mode.

Explainability module 126 may provides model performance and explainability metrics to help with governance processes of a machine learning model (e.g., executed by server 106 or executed by a third-party). This includes SHapley Additive explanations (“SHAP”) plots for feature importance and explainability, ranking and recommendation model related metrics such as normalized discount cumulative gain (“NDCG”), hit-rate, and precision. These are available for both deep learning-based models and other models like gradient boosted decision trees. Explainability metrics for traditional tree-based models is a well-established field through methods like Tree-SHAP or local interpretable model-agnostic explanations (“LIME”). Disclosed are two different methods for explainability that work for both deep learning and non deep-learning models in the framework. The two methods may include LIME and SHAP for feature and model explainability.

Modeling framework application 104 may include one or more databases and software modules comprising application programming interface (“API”) 108, analytics interface 110, and recommendations 112. Modeling framework application 104 may allow a user to select a data configuration file, a model configuration file, and/or a run configuration file. Modeling framework application 104 may be platform agnostic and offer flexible installation options. Users may use a Pip install command, ensuring quick setup and deployment. Alternatively, users may use a SDK library of modeling framework application 104 on a user electronic device (e.g., user electronic device 102) to use tools and resources on the network with the user's projects.

The run configuration file may specify a sequence of functionality steps that can be executed including, for example, training an LLM, evaluating the trained model, training and evaluating, exporting the model artifact locally, exporting and saving the model artifact to a cloud, generating a prediction from a trained model and saving the prediction locally, and creating a SHAP bee-swarm plot for model explainability.

Analytics interface 110 may allow users to specify if they want to use SageMaker batch or real-time for inference depending on their use case

Recommendations 112 may comprise a model ranking system. Recommendations 112 may show prediction scores.

Server 106's one or more software modules may include model and development training module 120, authoritative model retraining module 122, explainability module 126, and/or trained model serving module 124. One or more databases of server 106 may be accessed and/or include instructions for the one or more software modules and/or data to be searched based on a user prompt. The one or more databases of server 106 may be one or more databases stored on a memory accessible by server 106 as part of the computer network and/or as a cloud database accessible by server 106.

Modeling framework application 104 executed by one or more processors of user electronic device 102 may communicate with server 106 to generate a response to a user query based on one or more documents, messages, attachments, and/or tenant policies through API 108. User electronic device 102 may be a computer configured to communicate over a wired or wireless interface with a computer network or Internet with server 106.

Model and development training module 120 may generate a LLM from an instance for processing data. Authoritative model retraining module 122 may include adapting to changing data distribution by enforcing a periodic full re-training of the model may be performed without changing its structure on both old and new data so the model can more effectively adapt to new data. The LLM model will be retrained from scratch using old and new data while keeping the model architecture a constant. Full model retraining will be performed periodically (e.g., every day, every five days, every month). For example, a monthly cadence provides sufficient time to collect new data.

In addition, incremental training may be implemented. The purpose of incremental training is to incrementally adapt the model specification to recent behaviors and customer patterns provided in fresh (recent) user interaction data. Two ways may take into account the incremental training: 1) take the old model artifact and update parameter weights based on the new data that's coming in; or 2) train a new model artifact from scratch without the “warm start” of the model weights already being used in the production model.

Either with scheduled retraining or incremental training, the data are ingested from ‘updated’ feature groups generated in the previous sections.

Data feature database 130 may include a number of databases of a network or systems of database (e.g., cloud-based). Data feature database 130 may comprise one or more feature groups such as feature groups 132, 134. Feature groups 132, 134 may include features that will be used as inputs to the model. Data feature database 130 may be used to create feature groups from profile database 140. Data feature database 130 may be constructed from raw data collected across various lines of business including different sectors (e.g., related to a credit card, an investment, a home purchase or ownership, a business), as well as interactions and preferences exhibited across online platforms and/or at one or more physical locations (e.g., customer service interaction). The personalization profile may be a collection of multiple tables, logically grouped and distributed, to create a detailed and dynamic representation of what is known about each customer. This enables businesses to tailor their offerings and communications, ensuring a more personalized and effective customer experience.

From the personalization profile, feature groups may be a transformation of the profile. A feature group is a second level logical grouping of semantically similar data features. Some examples of these feature groups are relationship feature group that includes multiple customer relationship with different types of products, or financial activity feature group that include inflows, outflows, etc. After obtaining these feature groups, they may be fed into a modelling framework to further conduct data preprocessing so that the data is ready for model development and training.

Profile database 140 may include a number of databases of a network or systems of database (e.g., cloud-based). Profile database 130 may comprise a profile such as customer profile, card and demand deposit account (“DDA”) transactions, interaction data, or similar. Profile database 140 may comprise a data loader or reader. Input data readers for commonly used personalization data sets may include reading credit card and/or DDA transactions, interaction data (e.g., a customer contacting the bank through message or phone, a customer visiting a bank, a customer buying or cancelling a product), and a customer profile (e.g., associated information such as name, customer identifier, accounts). Support for distributed data loaders is provided using Ray, Petastorm, Pandas, etc. to process large input data sets. Sanity checks for input data sets and features are also incorporated to ensure input data quality. This is an improvement over conventional systems that are unable to load data in an efficient manner for hundreds of thousands or millions of records. The data loader may upload the profile data, that the each profile data set of the profile data is associated with a customer identifier, satisfies a data quality check that ensures each personalization of the profile data is available and complete, and performs a sanity check to determine whether each personalization of the profile data is within an expected range (e.g., non-negative, between 1 and 0).

In some embodiments, profile database 140 may include hyperparameter tuning and custom implementations of bias mitigation and class weighting techniques appropriate for personalization data sets. The framework provides the capability to store and version the model artifacts along with the associated metrics. The framework may offer templates for SageMaker inference, supporting both batch and real-time processing, allowing seamless transitions with minimal code changes. It also integrates with other machine learning ecosystems, such as an asynchronous, agentic coding assistance (e.g., Jules) and a cloud computing platform (“AWS”). Integration with a low latency store for recommendation engine to access the model output is also supported by profile database 140.

In some embodiments, a number of APIs exposed by a server (e.g., server 106) may include a model generation API.

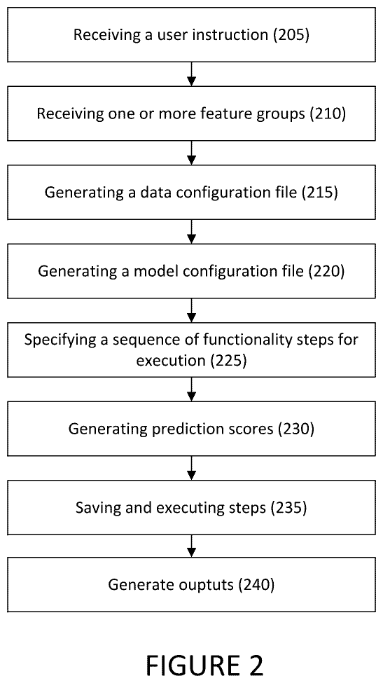

FIG. 2 is a method for automating model promotion in machine learning operations via LLM agents. The method may be stored as a list of instructions stored on a memory that when executed by one or more processors cause the one or more processors to perform the method.

Step 205 may include receiving a user instruction at an application executed by an electronic device. Step 205 may include receiving, at the application, a designation of a customer profile or a batch of customer profiles. Step 205 may include receiving, at the application, a location or input of a data configuration file, a model configuration file, and a run configuration file.

Step 210 may include generating, at a framework executed by a server, one or more feature groups based on the profile data. From a personalization profile including personalized data from customers, a data feature system may create feature groups. A feature group is a second level logical grouping of semantically similar data features sharing common input data and computed in the same deployment. Feature groups will be fed into the modeling framework for model development and training of a LLM. To continuously update the LLM, authoritative model re-training may be implemented to systematically update and improving a machine learning model by retraining it with new data or improved methodologies. This process is important for maintaining the accuracy and relevance of models in production environments. From the LLM being trained or retrained (use cases may include multiple models in the framework, not only one), feature and model explainability (by using the libraries integrated within the framework such as Shap, LIME) is produced, which is an important goal for model governance.

Step 215 may include generating, at the framework, a data configuration file. The data configuration file may include a preprocessing process. The preprocessing process may be applied to personalized data. The data configuration file may specifies the data characteristics such as the location of the training/evaluation data; data reader type (support distributed data loading); data parameters like number of data points for training/evaluation, and/or a number of data points used for model explainability.

Step 220 may include generating, at the framework, a model configuration file. The model configuration file may model config file specifies the model characteristics such as model type, model backend (e.g., TensorFlow, PyTorch, Sklearn, XGBoost, Statsmodels), model directory to export (local/S3), model hyperparameters, and/or hyperparameters tunning. The model configuration may include pointing to one or more files including a feature yaml that may contain information of features or feature groups that will be used as inputs to the LLM, a model ranker that defines any models desired as outputs and/or using a personalization model, a model inference yaml that specifies batch or real-time for inference.

Step 225 may include specifying, at the framework, a sequence of functionality steps for execution. The sequence may be generated by an explainability module consistent with disclosed embodiments.

Step 230 may include saving packages, at the framework, including generating prediction scores, saving artifacts, generating feature and model explainability and saving logs, at the electronic device, one or more outputs including, for example, a prediction based on the sequence of functionality steps. Outputs may include model serving including deploying trained machine learning models to a production environment where the deployed trained machine learning models can be accessed and used to make predictions or decisions in real-time or batch mode to show top-K number recommendations to the users.

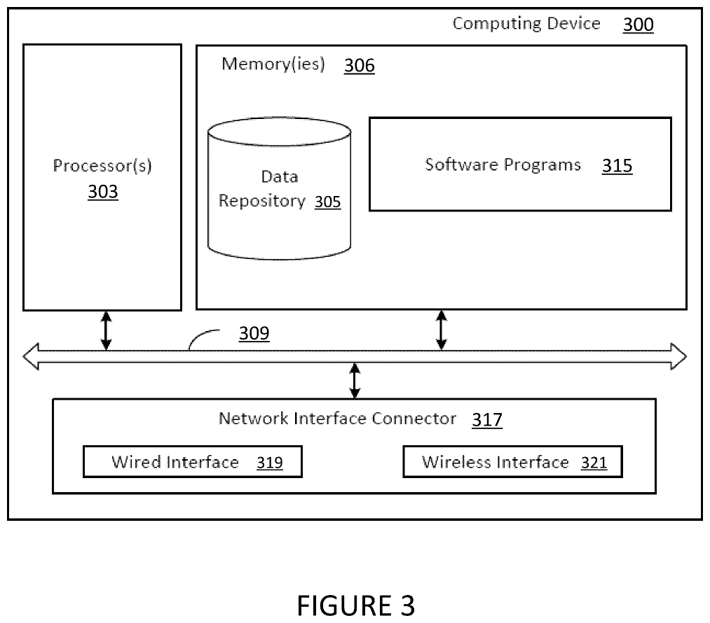

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method comprising:
receiving a user instruction at an application executed by an electronic device;
generating, at a framework executed by a server, one or more feature groups based on profile data;
generating, at the framework, a data configuration file;
generating, at the framework, a model configuration file;
specifying, at the framework, a sequence of functionality steps for execution;
generating, at the framework, a prediction score based on the sequence of functionality steps;
saving and executing, at the framework, the sequence of functionality steps; and
generating, at the electronic device, one or more outputs including, for example, a prediction based on the sequence of functionality steps.

2. The method of claim 1, wherein the data configuration file is based on the profile data and specifies data characteristics including location of LLM training and evaluation data, a data reader type, a data parameter including a number of data points for LLM training and evaluation, and a number of data points used for model explainability.

3. The method of claim 1, further comprising determining, by a data loader that uploads the profile data, that the each profile data set of the profile data is associated with a customer identifier, satisfies a data quality check that ensures each personalization of the profile data is available and complete, and performs a sanity check to determine whether each personalization of the profile data is within an expected range.

4. The method of claim 1, wherein the model configuration file comprises model characteristics include a model type, a model backend, a model directory to export, a model hyperparameter, and a tuning hyperparameter.

5. The method of claim 1, further comprising supporting, by the framework, batch and real-time processing based on a framework inference.

6. The method of claim 1, further comprising the profile being in a graph embedding format.

7. The method of claim 1, further comprising generating a SHAP plot for the feature groups including for feature importance and explainability.

8. The method of claim 1, further comprising regenerating the model based on the prediction being below a threshold, the regenerating being based on updating one or more parameter weights for new profile data.

9. The method of claim 1, further comprising regenerating a new LLM without updated parameters or previous inputs and with new profile data.

10. The method of claim 1, further comprising regenerating a new LLM periodically.

11. A system comprising at least one computer including a processor and a memory, wherein the at least one computer is configured to:
receive a user instruction at an application executed by an electronic device;
generate, at a framework executed by a server, one or more feature groups based on profile data;
generate, at the framework, a data configuration file;
generate, at the framework, a model configuration file;
specify, at the framework, a sequence of functionality steps for execution;
generate, at the framework, a prediction score based on the sequence of functionality steps;
save and execute, at the framework, the sequence of functionality steps; and
generate, at the electronic device, one or more outputs including, for example, a prediction based on the sequence of functionality steps.

12. The system of claim 11, wherein the data configuration file is based on the profile data and specifies data characteristics including location of LLM training and evaluation data, a data reader type, a data parameter including a number of data points for LLM training and evaluation, and a number of data points used for model explainability.

13. The system of claim 11, further comprising determining, by a data loader that uploads the profile data, that the each profile data set of the profile data is associated with a customer identifier, satisfies a data quality check that ensures each personalization of the profile data is available and complete, and performs a sanity check to determine whether each personalization of the profile data is within an expected range.

14. The system of claim 11, wherein the model configuration file comprises model characteristics include a model type, a model backend, a model directory to export, a model hyperparameter, and a tuning hyperparameter.

15. The system of claim 11, further comprising supporting, by the framework, batch and real-time processing based on a framework inference.

16. The system of claim 11, further comprising the profile being in a graph embedding format.

17. The system of claim 11, further comprising generating a SHAP plot for the feature groups including for feature importance and explainability.

18. The system of claim 11, further comprising regenerating the model based on the prediction being below a threshold, the regenerating being based on updating one or more parameter weights for new profile data.

19. The system of claim 11, further comprising regenerating a new LLM without updated parameters or previous inputs and with new profile data.

20. The system of claim 11, further comprising regenerating a new LLM periodically.
